(19) United States
(12) Patent Application Publication
(10) Pub. No.: US 2011/0311834 A1
(43) Pub. Date: Dec. 22, 2011

(54) TWO-LAYER FLEXIBLE SUBSTRATE, AND COPPER ELECTROLYTIC SOLUTION FOR PRODUCING SAME

(75) Inventor: Mikio Hanafusa, Ibaraki (JP)

(73) Assignee: JX NIPPON MINING & METALS CORPORATION, Tokyo (JP)

(21) Appl. No.: 13/138,535

(22) PCT Filed: Mar. 23, 2010
(86) PCT No.: PCT/JP2010/054974

§ 371 Date: Aug. 31, 2011

(30) Foreign Application Priority Data
Mar. 23, 2009 (JP) 2009-070361

(51) Int. Cl. B32B 15/02; C25D 3/38; B32B 15/08

(52) U.S. Cl. 428/553; 428/323; 205/291

(57) ABSTRACT

It is an object of the invention to provide a two-layer flexible substrate that excels in folding endurance and free from occurrence of Kirkendall voids or the like even when lead portions of COF are plated with tin and heat treatment is performed. The present invention is directed to a two-layer flexible substrate in which a copper layer is provided on one or both faces of an insulating film by using a copper electrolytic solution, wherein an average size of copper crystal grains constituting the copper layer is equal to or greater than 1 μm and equal to or less than a thickness of the copper layer, and a ratio of peak intensity of (200) to a sum total of intensities of six principal peaks {[peak intensity of (200)]/[sum total of peak intensities of (111), (200), (220), (311), (400), (331)]} in the X-ray diffraction of the copper layer is equal to or greater than 0.4. The above copper electrolytic solution for forming the copper layer contains a chloride ion and one or more of thiourea, thiourea derivatives, and thiosulfuric acid as additives.

### TECHNICAL FIELD

The present invention relates to a two-layer flexible substrate and a copper electrolytic solution for producing the same, and more specifically to a two-layer flexible substrate in which a copper layer is formed on an insulating film, and a copper electrolytic solution for producing the same.

### BACKGROUND ART

Two-layer flexible substrates are attracting attention as substrates for use in preparing flexible wiring boards. The advantage of a two-layer flexible substrate, in which a copper conductor layer is provided directly on an insulating film without the use of an adhesive, is that not only can the substrate itself be thinner, but the copper conductor layer to be deposited can also be adjusted to any desired thickness. Such a two-layer flexible substrate is normally manufactured by first forming an underlying metal layer on the insulating film, and then applying copper electroplating.

However, a large number of pinholes are formed and exposed portions of the insulating film are thereby created in the underlying metal layer thus obtained, and when a thin-film copper conductor layer is provided, the exposed portions created by pinholes cannot be filled with copper and pinholes also appear on the copper conductor layer surface, thereby causing wiring defects. As a means for resolving such problem, for example, Patent Document 1 describes a method for producing a two-layer flexible substrate in which an underlying metal layer is fabricated on an insulating film by a dry plating method, and after a primary electroplated copper film is formed on the underlying metal layer, an alkali solution treatment is performed, then an electroless copper plating layer is deposited, and finally a secondary electroplated copper layer is formed. However, this method involves a complex process.

Due to the recent trend toward higher-density printed wiring boards, moreover, there is a demand for copper layers that allow for smaller circuit widths and fine patterning in multiple layers. Two-layer flexible substrates are often folded during use, so the copper layer needs to have excellent folding endurance.

In particular, in recent years, the number of pins and lead portions (connection portions (inner leads, outer leads) of COF (Chip on film) in two-layer flexible substrates has increased, the line/space (the width of a line and the width of a space, or a combined width of line and space) has decreased, the wiring lines have decreased in size, and the probability of breakage during folding performed when the COF is mounted has increased. Therefore, the folding endurance that is more excellent than the current folding endurance is required for two-layer flexible substrates. Further, the lead portions of COF are plated with tin and a heat treatment is performed. Where fine crystals with a crystal grain size of about several hundreds of nanometers are present in a copper layer, when the heat treatment is performed, voids called Kirkendall voids appear due to a difference in diffusion rate between copper and tin, and the tin film peels off, thereby causing a short circuit. Accordingly, a two-layer flexible substrate is required in which Kirkendall voids do not occur.

In copper-clad laminates using a rolled copper foil, a significant increase in orientation of a (200) plane of the rolled copper foil and an increase in crystal grain size are thought to lead to an increase in folding endurance (see Non-patent Document 1). However, in a two-layer flexible substrate produced by forming an underlying metal layer by sputtering or the like on an insulating film such as polyimide and then electroplating a copper layer to a predetermined thickness, when the copper layer is formed by electroplating, copper nucleation randomly occurs and therefore only crystal grains with a size of less than 1 μm can be obtained.

### CITATION LIST

### Patent Document

Patent Document 1: Japanese Patent Publication No. 10-193505A.

### Non Patent Document

Non patent Document 1: Takemi MUROGA et al., “Development of Highly Flexible Rolled Copper Foils for FPC”, Technical Journal Hitachi Cable Review, Hitachi Cable Ltd., No. 26, 27-30 (2007-1).

### SUMMARY OF INVENTION

### Technical Problem

It is an object of the invention to provide a two-layer flexible substrate that excels in an MIT property (folding endurance). It is another object of the invention to provide a two-layer flexible substrate in which Kirkendall voids or the like do not occur even when lead portions of COF are plated with tin and heat treatment is performed.

### Solution to Problem

The inventors have investigated an MIT property of a two-layer flexible substrate and have already discovered that when a copper layer is formed by using an electrolytic solution including a chloride ion, a sulfur-containing organic compound, and polyethylene glycol as additives, an MIT property and a surface roughness (Rz) of the copper layer can be set within the predetermined ranges and thereby a two-layer flexible substrate that excels in an MIT property and adhesion to a resist and has no surface defects can be obtained (WO 2008/126522). It was also discovered that the MIT property can be improved by conducting a heat treatment (at a temperature equal to or less than 200° C.) or the like as a post-treatment of the produced two-layer flexible substrate (WO 2009/084412).

Subsequent comprehensive research conducted by the inventors demonstrated that the MIT property can be significantly improved by setting an average size of copper crystal grains constituting a copper layer of a two-layer flexible substrate to a value equal to or greater than 1 μm and increasing a peak intensity of (200) in the X-ray diffraction and also that the copper layer can be formed by using a specific additive to the electrolytic solution. These findings led to the creation of the present invention.

Thus, the present invention includes the following features.

(1) A two-layer flexible substrate in which a copper layer is provided on one or both faces of an insulating film by using a copper electrolytic solution, wherein an average size of copper crystal grains constituting the copper layer is equal to or greater than 1 μm and equal to or less than a thickness of the copper layer, and a ratio of peak intensity of (200) to a sum total of intensities of six principal peaks {[peak intensity of (200)]/[sum total of peak intensities of (111), (200), (220), (311), (400), (331)]} in an X-ray diffraction of the copper layer is equal to or greater than 0.4.

(2) The two-layer flexible substrate according to clause (1) above, wherein the copper layer includes, within a 50-μm field of view in a substrate plane direction, four or more copper crystal grains with a grain size extending from a copper layer face on the insulating film side to a copper layer surface.

(3) The two-layer flexible substrate according to clause (1) or (2) above, wherein an underlying metal layer including at least one selected from the group consisting of Ni, Cr, Co, Ti, Cu, Mo, Si, and V is provided on the insulating film, and the copper layer is formed on the underlying metal layer.

(4) The two-layer flexible substrate according to any one of clauses (1) to (3) above, wherein the insulating film is a polyimide film.

(5) The two-layer flexible substrate according to any one of clauses (1) to (4) above, wherein an MIT property is equal to or more than 300 times.

(6) A copper electrolytic solution for forming a copper layer of the two-layer flexible substrate according to any one of clauses (1) to (5) above, wherein a chloride ion and at least one selected from the group consisting of thiourea, thiourea derivatives, and thiosulfuric acid are included as additives.

(7) A method for producing a two-layer flexible substrate, including forming a copper layer on an insulating film by using the copper electrolytic solution described in clause (6) above.

### Advantageous Effects of Invention

In the two-layer flexible substrate fabricated using the copper electrolytic solution in accordance with the present invention, the average size of copper crystal grains constituting the copper layer is made equal to or greater than 1 μm and equal to or less than the thickness of the copper layer, and a ratio of peak intensity of (200) to a sum total of intensities of six principal peaks in the X-ray diffraction of the copper layer is made equal to or greater than 0.4, thereby making it possible to obtain an MIT property of equal to or greater than 300 times. Further, when a heat treatment is performed during wiring, no Kirkendall voids occur.

### BRIEF DESCRIPTION OF DRAWINGS

FIG. 1 is an explanatory drawing of a method for measuring an average grain size of copper crystal grains in the copper layer.

FIG. 2 shows a pattern used in MIT measurements.

FIG. 3 is an XRD spectrum of the copper layer obtained in Example 3.

FIG. 4 is a scanning ion microscope image of a cross section of the copper layer obtained in Example 6.

FIG. 5 is a scanning ion microscope image of a cross section of the copper layer obtained in Comparative Example 8.

FIG. 6 is an explanatory drawing illustrating how the number of Kirkendall voids is measured.

### DESCRIPTION OF EMBODIMENTS

In the two-layer flexible substrate in accordance with the present invention, a copper layer is formed on an insulating film, but it is preferred that an underlying metal layer be formed on the insulating film and then a copper layer of a predetermined thickness be electroplated on the underlying metal layer.

Examples of insulating films used in accordance with the present invention include films constituted by one or a mixture of two or more resins of thermosetting resins such as a polyimide resin, a polyester resin and a phenolic resin, thermoplastic resins such as a polyethylene resin, condensation polymers such as a polyamide, etc. A polyimide film, a polyester film, etc. are preferred, and a polyimide film is especially preferred. A variety of polyimide films, for example Kapton (manufactured by DU PONT-TORAY CO., LTD.) and Upilex (manufactured by UBE INDUSTRIES, LTD.) can be used as the polyimide film.

A film with a thickness of 10 μm to 50 μm is preferred as the insulating film.

An underlying metal layer constituted by a single element such as Ni, Cr, Co, Ti, Cu, Mo, Si, and V or a mixed system thereof can be formed on the insulating film by a well-known method such as vapor deposition, sputtering, or plating. The underlying metal layer may be formed of two or more layers. For example, a Ni—Cr layer may be formed by sputtering or the like and then a copper layer may be formed by sputtering on the like thereupon.

The thickness of the underlying metal layer is preferably 10 nm to 500 nm.

In the two-layer flexible substrate in accordance with the present invention, a copper layer is preferably formed using the copper electrolytic solution in accordance with the present invention on the insulating film on which the underlying metal layer has been formed as described above.

Copper sulfate, a solution obtained by dissolving metallic copper in sulfuric acid, or the like can be used as a copper ion source used in the copper electrolytic solution. The copper electrolytic solution is used upon addition of additives to an aqueous solution of a compound or a solution obtained by dissolving metallic copper with sulfuric acid, as the copper ion source. The concentration of copper in the copper electrolytic solution is preferably 15 g/L to 90 g/L, and the concentration of sulfuric acid is preferably 50 g/L to 200 g/L.

The copper electrolytic solution in accordance with the present invention is obtained by introducing a chloride ion (Cl⁻) and one, or two or more from among thiourea, thiourea derivatives, and thiosulfuric acid to an aqueous solution including a copper ion source, such as an aqueous solution of copper sulfate.

The chloride ion in the copper electrolytic solution can be introduced, for example, by dissolving a compound including a chloride ion, such as NaCl, MgCl₂, or HCl, in an electrolytic solution.

The thiourea derivatives are preferably compounds in which a hydrogen atom of thiourea is substituted with a lower alkyl group, examples of such compounds including tetraethyl thiourea (SC(N(C₂H₅)₂)₂), tetramethyl thiourea, 1,3-diethyl thiourea (C₂H₅NHCSNHC₂H₅), and 1,3-dimethyl thiourea.

The copper electrolytic solution in accordance with the present invention preferably includes the chloride ion in an amount of equal to or greater than 2.5 ppm, more preferably 5 ppm to 200 ppm, and even more preferably 25 ppm to 80 ppm. When thiourea and/or thiourea derivative or derivatives is used, the sum total amount of thiourea and thiourea derivative(s) is preferably 0.02 ppm to 10 ppm, more preferably 0.2 ppm to 7.5 ppm. When thiosulfuric acid is used, the amount of thiosulfuric acid is preferably 0.1 ppm to 150 ppm, more preferably 1 ppm to 100 ppm, and even more preferably 3 ppm to 20 ppm. Thiourea, thiourea derivative(s), and thiosulfuric acid may be used together.

Where the concentration of chloride ion is too high, the copper layer surface is roughened similarly to that of the typical copper foil. Where the amount of chloride ion is small, crystal grains are very small and an MIT property is degraded. When the concentrations of thiourea, thiourea derivatives, and thiosulfuric acid are outside the preferred ranges, the size of crystal grains is decreased and the MIT property is degraded.

Where a chloride ion and one, or two or more from among thiourea, thiourea derivatives, and thiosulfuric acid are used as additives, the average grain size of copper crystal grains constituting the copper layer can be made equal to or greater than 1 μm and equal to or less than the copper layer thickness, a ratio of peak intensity of (200) to a sum total of intensities of six principal peaks in the X-ray diffraction of the copper layer can be made equal to or greater than 0.4, and a two-layer flexible substrate can be obtained which excels in MIT property and has no Kirkendall voids. The sum total of intensities of six principal peaks is the sum total of peak intensities of (111), (200), (220), (311), (400), (331) in the X-ray diffraction. In this case, it is important that the peak intensity of (200) in the X-ray diffraction be within the abovementioned range, and the MIT property is further improved by increasing the crystal grain size.

The ratio of peak intensity of (200) to a sum total of intensities of the six principal peaks is preferably 0.5 to 0.8.

In accordance with the present invention, by using a specific copper electrolytic solution, it is possible to increase the orientation of (200) plane, obtain an average crystal grain size of copper crystal grains constituting the copper layer of equal to or greater than 1 μm, and greatly improve the folding endurance. The MIT property is further improved by forming a copper layer in which four or more copper crystal grains with a grain size extending from the copper layer face on the insulating film side to the copper layer surface are present within a 50-μm range in the substrate plane direction (direction parallel to the substrate plane) in cross-sectional observations in the film thickness direction. From the standpoint of improving the MIT property, it is preferred that the average crystal grain size of copper crystal grains be equal to or more 2 μm, even more preferably equal to or greater than 4 μm. The number of crystal grains with a grain size extending from the copper layer face on the insulating film side to the copper layer surface that are present within a 50-μm range in the substrate plane direction is preferably 6 to 8.

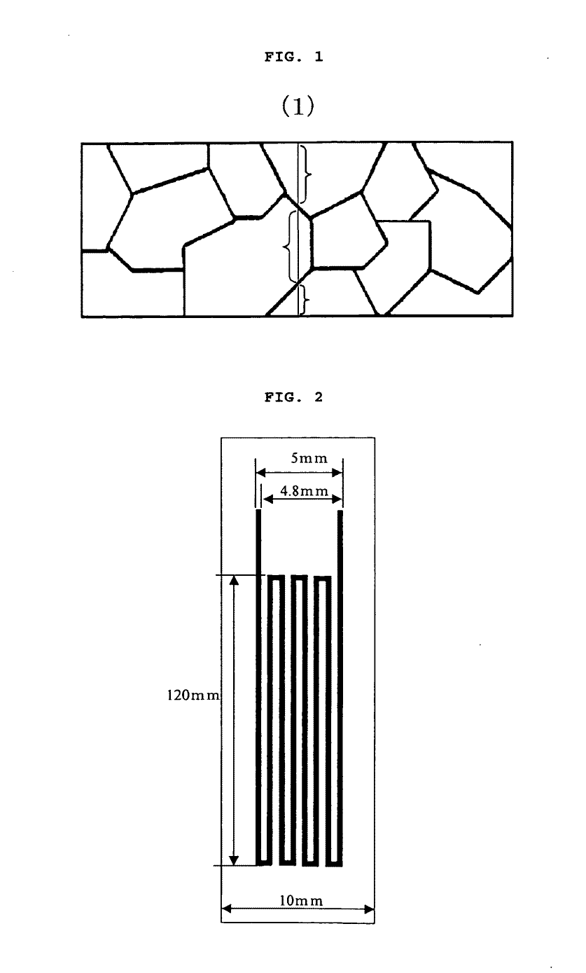

The average grain size of copper crystal grains constituting the copper layer was measured in the following manner. Cross sections in five locations were cut with a FIB-SIM, a vertical line connecting the insulating film surface and the copper surface was drawn in the central portion of each cross section according to the intersect method specified in JIS J H0501 in the cross-sectional observations, and the size of the crystal passing across the vertical line was measured as a crystal grain size. The crystal grain size was measured in the five cross sections, and the average value thereof was taken as the average grain size of copper crystal grains. More specifically, in the schematic diagram of the cross section obtained with a FIB-SIM and shown in FIG. 1, the intersect length of each grain passing across (intersecting) the vertical line (1) drawn in the central portion of the cross section was measured as a crystal grain size, the crystal grain sizes in cross sections of a total of the five locations were measured in the same manner, and the average value thereof was taken as the average grain size.

The number of crystal grains with a grain size extending from the face on the insulating film side to the copper layer surface was also determined by observing the cross sections in the aforementioned five locations obtained with the FIB-SIM and determining the average value.

In the copper electrolytic solution in accordance with the present invention, in addition to the abovementioned chloride ion, thiourea, thiourea derivative, and thiosulfuric acid, a surfactant, for example, polyethylene glycol, that has been used for the usual copper plating may be added as an additive.

In the two-layer flexible substrate in accordance with the present invention, a copper layer is provided by electroplating on the substrate provided with an underlying metal layer by using the above-mentioned copper electrolytic solution. In this case, the electroplating is preferably at a bath temperature of 30° C. to 55° C., more preferably 35° C. to 45° C. It is preferred that a copper layer with a thickness of 3 μm to 18 μm be formed.

The two-layer flexible substrate fabricated by using the copper electrolytic solution in accordance with the present invention has an excellent MIT property of at least 300 times, which is two or more times the presently attained property, in the folding endurance test measured at a load of 500 g and R=0.8 according to JIS C 5016. Thus the two-layer flexible substrate is excellent in MIT property. It is more preferred that the MIT property be equal to or greater than 500 times.

In the two-layer flexible substrate fabricated by using the copper electrolytic solution in accordance with the present invention, the average grain size of copper crystal grains constituting the copper layer is equal to or greater than 1 μm. Therefore, Kirkendall voids do not occur even when a heat treatment is conducted during subsequent wiring, for example, when a heat treatment is conducted after plating the lead portions of COF with tin.

### EXAMPLE

The present invention will be explained below on the basis of examples thereof, but the present invention is not limited to the examples.

### Examples 1 to 13 and Comparative Examples 1 to 7

Additives were added to the aqueous solutions obtained by using copper sulfate and sulfuric acid at the below-described concentrations, and electroplating was carried out on a polyimide film having an underlying metal layer under the below-described plating conditions so that a copper coating film with a thickness of about 8 μm was formed. The bath temperature was 40° C. The additives and the added amounts thereof are shown in Table 1. The units of the amounts of additives in Table 1 are ppm. Hydrochloric acid was used as chloride ion source.

Liquid volume: 1700 mL.

Anode: lead electrode.

Cathode: rotating electrode around which the polyimide film having an underlying metal layer was wrapped.

Polyimide film having an underlying metal layer: a film obtained by sputtering Ni—Cr to a thickness of 150 Å on Kapton E (Du Pont) with a thickness of 37.5 μm and then sputtering copper to a thickness of 2000 Å.

Current·Time: 2800 As

Current density: the current density is held for 35 sec at each of the following values in the order of description: 5→>15→+25→>40 A/dm².

Cathode revolution speed: 90 r.p.m.

Copper ion: 70 g/L.

Free sulfuric acid: 60 g/L.

### Comparative Example 8

A copper-coated polyimide two-layer substrate was obtained by electroplating copper on a polyimide film having an underlying metal layer in the same manner as in Example 1, except that the additives to the copper electrolytic solution in Example 1 were replaced with a chloride ion at 60 ppm, commercially available additives Copper Gleam 200A (manufactured by LeaRonal Japan Inc.) at 0.4 mL/L, and Copper Gleam 200B (manufactured by LeaRonal Japan Inc.) at 5 mL/L. Copper Gleam 200A and Copper Gleam 200B are commercially available additives for copper electrolytic solutions for printed boards.

The obtained copper-coated polyimide two-layer substrates were evaluated in the following manner.

(1) MIT Property

Each MIT test piece shown in FIG. 2 was prepared by forming a wiring pattern with a line width of 200 μm on each obtained copper-coated polyimide two-layer substrate by the ordinarily practiced steps of liquid resist coating, exposure, development and etching and the test piece was used for measurements conducted at a load of 500 g and R=0.8 according to JIS C 5016.

(2) Observations of Kirkendall Voids

A wiring pattern was formed on the obtained copper-coated polyimide two-layer substrates by the ordinarily practiced steps of liquid resist coating, exposure, development and etching, except that the line width in the pattern shown in FIG. 2 was 50 μm. Tin was then plated on the circuit having such a wiring pattern by using a commercially available tin plating solution (manufactured by ISHIHARA CHEMICAL CO., LTD), and then a heat treatment was conducted for one hour at 150° C. The sample thus obtained was subjected to cross-sectional processing with a FIB (focused ion beam processing device) in the wiring width direction of the wiring pattern and the number of generated Kirkendall voids present in the entire line cross section was determined as shown in FIG. 6.

(3) The average grain size of copper crystal grains constituting the copper layer and the number of crystal grains with a size equal to the copper layer thickness within a range of 50 μm were determined by conducting cross section processing of the obtained copper-coated polyimide two-layer substrates with a FIB and observing a width of 50 μm under a scanning ion microscope.

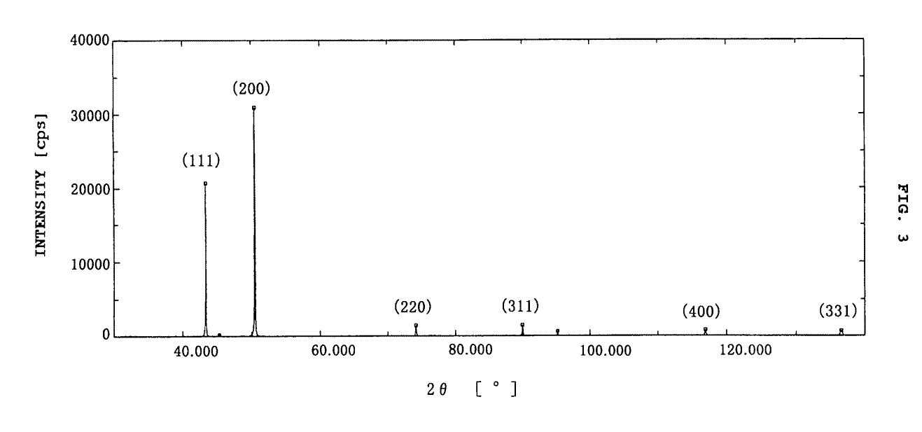

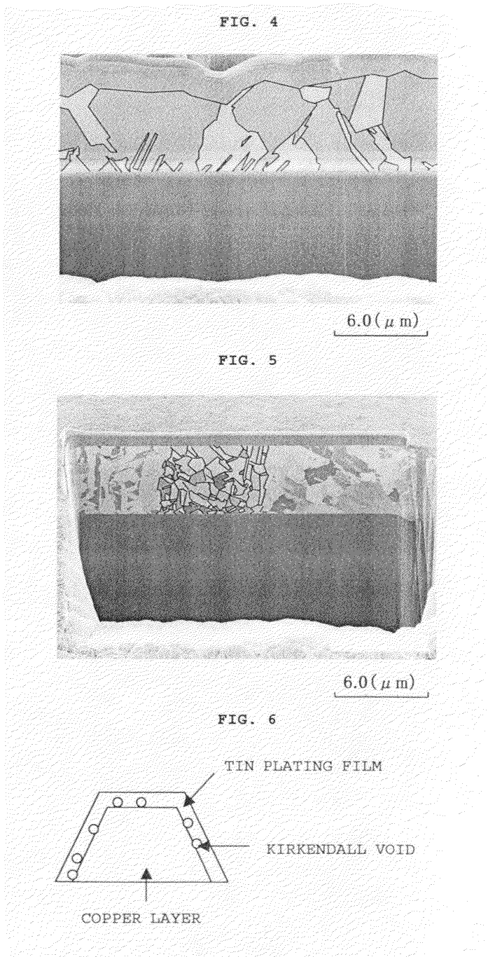

An XRD spectrum of the copper layer obtained in Example 3 is shown in FIG. 3. A scanning ion microscope image of the cross section of the copper layer obtained in Example 6 is shown in FIG. 4. A scanning ion microscope image of the cross section of the copper layer obtained in Comparative Example 8 is shown in FIG. 5. In FIGS. 4 and 5, parts of grain boundaries are traced by the lines to illustrate the grain boundaries.

The results are shown in Table 1.

TABLE 1

| | | | | | | | Crystal | | |
|---|---|---|---|---|---|---|---|---|---|
| | | | | | Number of | Ratio of | grain | | Number of |
| | | | Diethyl | Thiosulfuric | crystal | intensity of | size | MIT | Kirkendall |
| | Cl | Thiourea | thiourea | acid | grains | (200) | (μm) | property | voids |
| Example 1 | 5 | 1 | 0 | 0 | 5 | 0.61 | 4.6 | 874 | 0 |
| Example 2 | 60 | 1 | 0 | 0 | 7 | 0.52 | 4.1 | 1526 | 0 |
| Example 3 | 100 | 1 | 0 | 0 | 6 | 0.49 | 3.3 | 1722 | 0 |
| Example 4 | 250 | 1 | 0 | 0 | 4 | 0.41 | 1.3 | 1570 | 0 |
| Example 5 | 60 | 0.02 | 0 | 0 | 4 | 0.4 | 1.1 | 324 | 0 |
| Example 6 | 60 | 0.5 | 0 | 0 | 5 | 0.5 | 4.2 | 1340 | 0 |
| Example 7 | 60 | 10 | 0 | 0 | 6 | 0.48 | 3.8 | 461 | 0 |
| Example 8 | 60 | 0 | 0.02 | 0 | 5 | 0.44 | 1.8 | 515 | 0 |
| Example 9 | 60 | 0 | 1 | 0 | 7 | 0.59 | 5.2 | 1135 | 0 |
| Example 10 | 60 | 0 | 10 | 0 | 5 | 0.51 | 4.9 | 328 | 0 |
| Example 11 | 60 | 0 | 0 | 0.1 | 5 | 0.54 | 5.1 | 380 | 0 |
| Example 12 | 60 | 0 | 0 | 10 | 7 | 0.76 | 5.9 | 1352 | 0 |
| Example 13 | 60 | 0 | 0 | 150 | 6 | 0.53 | 4.8 | 659 | 0 |
| Comp. Ex. 1 | 60 | 0.01 | 0 | 0 | 4 | 0.32 | 0.9 | 191 | 0 |
| Comp. Ex. 2 | 60 | 15 | 0 | 0 | 2 | 0.57 | 0.7 | 52 | 0 |
| Comp. Ex. 3 | 0 | 1 | 0 | 0 | 0 | 0.58 | 0.3 | 185 | 8 |
| Comp. Ex. 4 | 60 | 0 | 0.01 | 0 | 4 | 0.21 | 0.9 | 152 | 0 |
| Comp. Ex. 5 | 60 | 0 | 15 | 0 | 3 | 0.38 | 0.7 | 56 | 0 |
| Comp. Ex. 6 | 60 | 0 | 0 | 0.05 | 4 | 0.29 | 0.7 | 215 | 0 |
| Comp. Ex. 7 | 60 | 0 | 0 | 200 | 3 | 0.33 | 0.6 | 231 | 0 |
| Comp. Ex. 8* | 60 | — | — | — | 0 | 0.38 | 0.8 | 182 | 2 |

*Commercially available Copper Gleam 200A and 200B were used at 0.4 mL/L and 5 mL/L, respectively, as additives in the copper electrolytic solution of Comparative Example 8.

1. A two-layer flexible substrate in which a copper layer is provided on one or both faces of an insulating film by using a copper electrolytic solution, wherein an average size of copper crystal grains constituting the copper layer is equal to or greater than 1 μm and equal to or less than a thickness of the copper layer, and a ratio of peak intensity of (200) to a sum total of intensities of six principal peaks {[peak intensity of (200)]/[sum total of peak intensities of (111), (200), (220), (311), (400), (331)]} in an X-ray diffraction of the copper layer is equal to or greater than 0.4.

2. The two-layer flexible substrate according to claim 1, wherein the copper layer includes, within a range of 50-μm in a substrate plane direction, four or more copper crystal grains with a grain size extending from a copper layer face on an insulating film side to a copper layer surface.

3. The two-layer flexible substrate according to claim 1, wherein an underlying metal layer including at least one selected from the group consisting of Ni, Cr, Co, Ti, Cu, Mo, Si, and V is provided on the insulating film, and the copper layer is formed on the underlying metal layer.

4. The two-layer flexible substrate according to claim 1, wherein the insulating film is a polyimide film.

5. The two-layer flexible substrate according to claim 1, wherein an MIT property is equal to or more than 300 times.

6. A copper electrolytic solution for forming a copper layer of the two-layer flexible substrate according to claim 1, wherein a chloride ion and at least one selected from the group consisting of thiourea, thiourea derivatives, and thiosulfuric acid are included as additives.

7. A method for producing a two-layer flexible substrate, including forming a copper layer on an insulating film by using the copper electrolytic solution described in claim 6.
